(19) United States
(12) Patent Application Publication
(10) Pub. No.: US 2004/0046975 A1
(43) Pub. Date: Mar. 11, 2004

(54) Print method of increasing front-facing-feeling keeping angle and printed material having increased front-facing-feeling keeping angle

(76) Inventor: Hiroshi Saito, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/238,735

(22) Filed: Sep. 11, 2002

(51) Int. Cl. G06K 1/00; G06F 15/00

(52) U.S. Cl. 358/1.5; 358/1.18

(57) ABSTRACT

An object of the present invention is to allow a person to view a subject with a feeling as if he/she faces a front of the subject even at a predetermined angle.

The object of the present invention has been achieved by a print method of increasing a front-facing feeling keeping angle comprising the steps of creating a composition image by adding the pixels of a left-side recorded image and/or the pixels of a right-side recorded image to a front-facing recorded image, making an original plate using the composite image, and conducting printing.

### BACKGROUND OF THE INVENTION

1. Field of the Invention

The present invention relates to a print method of increasing a front-facing-feeling keeping angle and a printed material having an increased front-facing-feeling keeping angle in order to immediately increase an angle at which a person visually can feel as if he or she faces the front of a subject printed on a poster and the like, as much as possible.

2. Description of the Related Art

There is conventionally known a photograph on which a subject such as a person is provided with a three-dimensional feeling by recording the subject on a negative film, on which the subject has been recorded from the front of it, in a superimposing manner by moving the subject in the left and right directions.

Further, there is also a picture which provides a person with such a illusionary feeling as if a subject drawn on the picture faces the front of the person not only when he or she views the subject in front of it but also when he or she views the subject at positions somewhat offset right and left.

However, the superimposed photograph is a photograph for providing the person with the three-dimensional feeling by permitting the subject to be viewed in the lateral direction thereof and does not increase an angle at which the person can feel as if he or she faces the front of the subject.

Further, there is also a picture of a portrait and the like in which an angle, at which a person obtains such a feeling as if he or she faces the front of the subject (the feeling is referred to as “front-facing-feeling” in this specification), is relatively increased, and this feeling is achieved by the technique of the painter of the picture. When a printed material is printed from an original plate made from the picture drawn by the technique, a certain degree of front-facing-feeling can be obtained. However, the effect of the front-facing-feeling of the picture cannot help being reduced, and it is difficult to express the front-facing-feeling only by a print technology.

### SUMMARY OF THE INVENTION

The present invention has developed a novel print technology capable of obtaining a front-facing-feeling, regardless of a conventional photograph on which a subject is superimposed as described above, by obtaining a composite image by combining the pixels of a front-facing recorded image on which a subject is recorded from the front of it, the pixels of a left-side recorded image on which the subject is recorded at a position moved left from the front of it, and the pixels of a right-side recorded image on which the subject is recorded at a position moved right from the front of it at an appropriate ratios.

That is, a print method of the present invention is a print method of increasing a front-facing-feeling keeping angle by the steps of creating a composite image by adding the pixels of a left-side recorded image of a subject and/or the pixels of a right-side recorded image of the subject to the pixels of a front-facing recorded image of the subject, making an original plate using the composite image, and outputting a print using the original plate.

Here, the front-facing-feeling keeping angle is an angle from the front direction of a printed material (printed subject) at which the printed material can be viewed while keeping a front-facing-feeling.

Further, the front-facing recorded image is an image on which the subject is recorded from the front of it (while facing the front of the subject), and the left-side and right-side recorded images are images on which the subject is recorded from positions moved left and right from the front of the subject, respectively.

These front-facing recorded image, left-side recorded image, and right-side recorded image can be obtained by directly recording the subject from the front (front-facing direction), left and right thereof, respectively. Further, it is also possible to record the subject from the front of it (front-facing direction) and using it as an original picture, and further to obtain the front-facing recorded image by recording the original picture from the front of it (front-facing direction) and to obtain the left-side recorded image and the right-side recorded image by recording the original picture from left and right directions spaced apart from the front-facing direction at a certain angle.

The composite image can be created by combining the pixels of the front-facing image, left-side recorded image and right-side recorded image having been obtained as described above, and finally, original plate can be made by using the composite image.

One or a plurality of the left-side recorded images are recorded at a position moved left from the front-facing direction within the range of 3° to 60°, and the pixels obtained therefrom can be combined. One or a plurality of the right-side recorded images are recorded at a position moved right from the front-facing direction within the range of 3° to 60° in the same way, and the pixels obtained therefrom can be combined.

When, for example, the ratio of the pixels of the front-facing recorded image is set to 50% of the pixels of the composite image, the 25% of the pixels of the left-side recorded image and 25% of the pixels of the right-side recorded image are combined, respectively. When 25% of the pixels of only an image recorded from one direction are combined, a resultant composite image is greatly different from the front-facing recorded image. Thus, the composite image can be made by recording the subject or the original picture at three different positions on the left of the front-facing direction and combining 8%, 8%, and 9% of the pixels of the three images obtained thereby, and further by recording the subject or the original picture on the right similarly and combining the pixels thereof at the same ratios. When the composite image is made as described above, seven images, that is, one front-facing recorded image, three left-side recorded images, and three right-side recorded images are combined.

The pixels of the front-facing recorded image, which is combined as the composite image, also can be combined with the pixels of the other images in the state in which the image is recorded from the front of it. Further, the pixels of the front-facing recorded image can be combined after they are extracted at an appropriate ratio from the state in which the image is recorded from the front of it, that is, after the pixel density of the image is reduced. This also applies to the pixels of the left-side recorded image and the pixels of the right-side recorded image likewise. That is, the pixels of the images can be combined with the pixels of the other images in the state in which the images are recorded, or can be combined therewith after the pixels of the images are extracted from the recorded states of the images at an appropriate ratio, that is, after the pixel densities of the images are reduced.

When the pixels are extracted at the appropriate ratio to reduce the pixel density and combined, they can be combined such that-the pixel density of the composite image coincides with the pixel densities of the respective recorded images before they are combined. That is, when it is assumed that the pixel densities of the respective recorded images as they are recorded are 100%, the composite image can be arranged to have a pixel density of 100%.

The extraction and combination of pixels when the pixels of the respective recorded images are extracted and combined will be explained.

The print method of the present invention can create a composite image by adding the pixels of the left-side recorded image of a subject and/or the pixels of the right-side recorded image of the subject to the pixels of the front-facing recorded image of the subject, can make an original plate using the composite image, and can output a print using the original plate. To simplify the explanation, however, a case will be explained here in which the composite image is obtained by adding the pixels of the right-side recorded image of the subject to the pixels of the left-side recorded image of the subject without adding the pixels of the front-facing recorded image of the subject.

Note that when the pixels of the front-facing recorded image are added, the combination method described below may be executed within a range from which the ratio at which the pixels of the front-facing recorded image are added is excluded. When, for example, the pixels of the front-facing recorded image are combined at a ratio of 20% on the entire surface of the image, the combination method described below may be executed taking it into consideration that the remaining 80% corresponds to 100%.

When the composite image is obtained by adding the pixels of the right-side recorded image of the subject to the pixels of the left-side recorded image of the subject, pixels are extracted from the left-side recorded image of the subject and the right-side recorded image of the subject, respectively at an extraction ratio of 100% to 0%. The composite image is obtained by combining the extracted pixels in such a manner that a total of the extraction ratios is 100% with respect to the pixel density of the left-side recorded image and the pixel density of the right-side recorded image on the entire surface of the composite image at all times. Then, an original plate can be made using the composite image, and a printed material can be printed using the original plate. The pixel density of the composite image can be caused to coincide with the pixel densities of the recorded images by combining the pixels as described above.

The extraction of the pixels of the respective recorded images (a job for reducing the pixel density) and the combination of the pixels can be executed at the same ratio on the entire surfaces of the recorded images.

When, for example, 50% of the pixels of the left-side recorded image are extracted from the entire surface thereof, 50% of the pixels of the right-side recorded image are extracted from the entire surface thereof, and these extracted pixels are combined, a composite image having the same density as those of the left-side recorded image and the right-side recorded image can be created.

Further, the composite image can be obtained considering that the extraction of the pixels of the respective recorded images (the job for reducing the pixel density) and the combination of the pixels are executed by “separating” the respective recorded images to appropriate ranges.

When, for example, the subject is recorded from a left and a right in the same number of pixels, 30% of the pixels of a certain separated range of the left-side recorded image are extracted, 70% of the pixels of the same range of the right-side recorded image are extracted, and these pixels are combined. With this operation, in these ranges, there can be obtained the composite image having a pixel density of 100% with respect to the pixel densities of the left-side recorded image and the right-side recorded image. When the above operation is executed to all the separated ranges of the recorded images, the pixel density of the composite image can be made to 100% on the entire surface thereof at all times with respect to the pixel densities of the left-side recorded image and the right-side recorded image.

Further, it is possible to change the extraction ratio so that the pixel density is gradually changed by making the above “separation” from one side edges of the recorded images to the other side edges thereof.

That is, it is possible to extract the pixels of the left-side recorded image of the subject by changing the extracting ratio in the range of 100% to 0% from the one side edge of the left-side recorded image to the other side edge thereof, to extract the pixels of the right-side recorded image of the subject by changing the extracting ratio in the range of 100% to 0% from the other side edge of the right-side recorded image to the one side edge thereof according to the extracting ratio of the pixels of the left-side recorded image, to obtain the composite image by combining the pixels extracted from the left-side recorded image with the pixels of the right-side recorded image, and to make an original plate using the composite image to thereby output a print using the original plate.

For example, the left-side recorded image is subjected to gradation processing by gradually changing the extraction ratio of the pixels thereof such that the ratio of the pixels is set to 100% at the left edge of the image, to 50% at the intermediate portion thereof, and to 0% at the right edge thereof. In contrast, the right-side recorded image is subjected to gradation processing by gradually changing the extraction ratio of the pixels thereof such that the ratio of the pixels is set to 100% at the right edge of the image, to 50% at the intermediate portion thereof, and to 0% at the left edge thereof. The respective pixels extracted by subjecting the recorded images to the gradation processing can be combined. With this operation, the pixel density of the composite image can be made to 100% on the entire surface thereof from the one side edge thereof to the other side edge thereof with respect to the pixel densities of the left-side recorded image and the right-side recorded image.

When the composite image is obtained by changing the extraction ratio of the pixels in the range of 90% to 10%, a printed material made using the composite image is such that the contour of the subject on the printed material is blurred and the subject seems as if it is moving. In contrast, the ratio of the pixels at any one of the recorded images on both the sides of the composite image is set to 100%, the contour of the subject can be sharpened.

A printed material of the present invention can be obtained by executing the print method of the present invention described above. That is, the printed material of the present invention is a-printed material having an increased front-facing-feeling keeping angle, wherein the printed material is made using the composite image acting as an original plate obtained by extracting the pixels of the front-facing recorded image of the subject, the left-side recorded image of the subject, and the right-side recorded image of the subject at an extracting ratio of 100% to 0% and by combining the thus extracted pixels such that a total of the extracting ratios of the extracted pixels is 100% on the entire surface of the composite image at all times.

In the present invention, the ratio of the pixels of the front-facing recorded image is set to 0% to 100%, whereas the ratios of the pixels of the left-side and right-side recorded images are set to 100% to 0%. Thus, when the subject on the original picture somewhat faces left or right, (is not symmetrical), the asymmetrical subject can be corrected by increasing the ratio of the pixels of the left-side or right-side recorded image. For example, it is possible to set the ratio of the pixels of the front-facing recorded image to 50%, the ratio of the pixels of the left-side recorded image to 35%, and the ratio of the pixels of the right-side recorded image to 15%.

An increase in the ratio of the pixels of the front-facing recorded image finishes the printed material sharp and distinct. In contrast, when the ratios of the pixels of the left-side and right-side recorded images are increased, the printed material can express a feeling of movement more strongly. That is, even if the person views the printed material is by moving left or right from the front of the printed material so as to be apart therefrom (by moving backward therefrom about three steps and moving left or right one half step), the person can strongly feel the front-facing-feeling.

As described above, since the printed material having been finished has a different effect by a combination ratio of the respective recorded images, it is preferable to determine the combination ratios of the pixels of the respective recorded images according to an application of the printed material.

For example, it is contemplated that the printed material, which is displayed in parallel with a direction where passengers (persons) walk, is seldom viewed from the front of it. In this case, when the ratio of the pixels of the front-facing recorded image is set to 0%, and the printed material is made using the composite image obtained by combining only the pixels of the left-side and right-side recorded images, the printed material can provide the passengers (persons) with a stronger front-facing-feeling.

Further, when the passengers (persons) walk in a predetermined direction along a one-way street, an effect of providing the passengers (persons) with the stronger front-facing-feeling can be exhibited by increasing the composite ratio of the pixels of the recorded image on the side to which the passengers persons) approach.

Further, when the left-side and right-side recorded images are recorded using the original picture, even if an image used as the original picture is not recorded from the front of it, the directionality of the image can be corrected by changing the composite ratios of the pixels of the respective recorded images.

While the pixels of the left-side and right-side recorded images are combined with the pixels of the front-facing recorded image at the predetermined ratios in the present invention, both or one of the pixels of upper-side and lower-side recorded images may be used. When, for example, a picture is displayed at the midpoint of a stepway, the front-facing-feeling can be obtained at angles somewhat upward or downward of the picture.

As described above, when the composite image is obtained by adding the pixels of the front-facing recorded image of the subject and the pixels of the left-side and right-side recorded images, the original plate is made using the composite image, and the printed material is printed using the original plate, the printed material is provided with a large front-facing-feeling keeping angle.

Further, the printed material may be finished with transparent varnish printed thereof. When the printed material is finished by printing the transparent varnish thereon, an original plate for printing the transparent varnish is made by combining the respective pixels obtained by recording the subject (or the original picture) from the left and right directions thereof, in addition to the composite image obtained by adding the pixels of the front-facing recorded image, the pixels of the left-side recorded image, and the pixels of the right-side recorded image, and the printed material is output using these two kinds of the original plates, thereby the printed material can be arranged as the printed material finished with the transparent varnish.

### BRIEF DESCRIPTION OF THE DRAWINGS

FIG. 1 is a block diagram of a print method of an embodiment of the present invention;

FIG. 2 is a conceptual diagram explaining the recording of a front-faced image, a left-side image and a right-side image in the print method of the present invention;

FIG. 3(A) is a conceptual diagram explaining the creation of a composite image of the embodiment of the present invention used for an original plate, and FIG. 3(B) is a conceptual diagram explaining the creation of an original plate of the embodiment of the present invention used for a varnish print; and

FIG. 4 is a conceptual diagram showing a difference between optical axes of the embodiment of the present invention.

### DESCRIPTION OF THE PREFERRED EMBODIMENTS

According to the present invention, a composite image of a subject is created in the following manner. That is, a front-facing recorded image is obtained by recording the subject from the front of it (in a front-facing state) and two left-side recorded images and two right-side recorded images are obtained by recording the subject in the directions of optical axes offset right and left at respective angles θ from the front of the subject (at positions offset right and left at respective angles θ from the front of the subject), and the composite image is created by combining 80% of the pixels of the front-facing recorded image and each 5% of the pixels of the respective two left-side and right-side recorded images. The original plate is made using the composite image.

Further, to print transparent varnish, an original plate may be made from a composite image obtained by adding each 50% of the pixels of left-side and right-side recorded images obtained by recording the subject in the directions of optical axes offset left and right at an angle 2θ from the front of the subject.

When a print is output from the original plate by a predetermined method, a printed material of the present invention is made.

In the above printed material, even if a person facing it from the front of it (person) moves, the person can keep a front-facing-feeling when he or she is located at a position within the range of 2θ on the left and right sides of the front-facing direction of the printed material.

For example, even if a poster of a person was viewed in an oblique direction (offset at 2θ from the front-facing direction), the person on the poster provided the person with such a illusionary feeling as if the person faced the front of him or her (as if the person faces toward him or her), thereby it was admitted that the thus displayed poster had a large effect. Preferable examples of the present invention will be specifically explained below.

### EXAMPLE 1

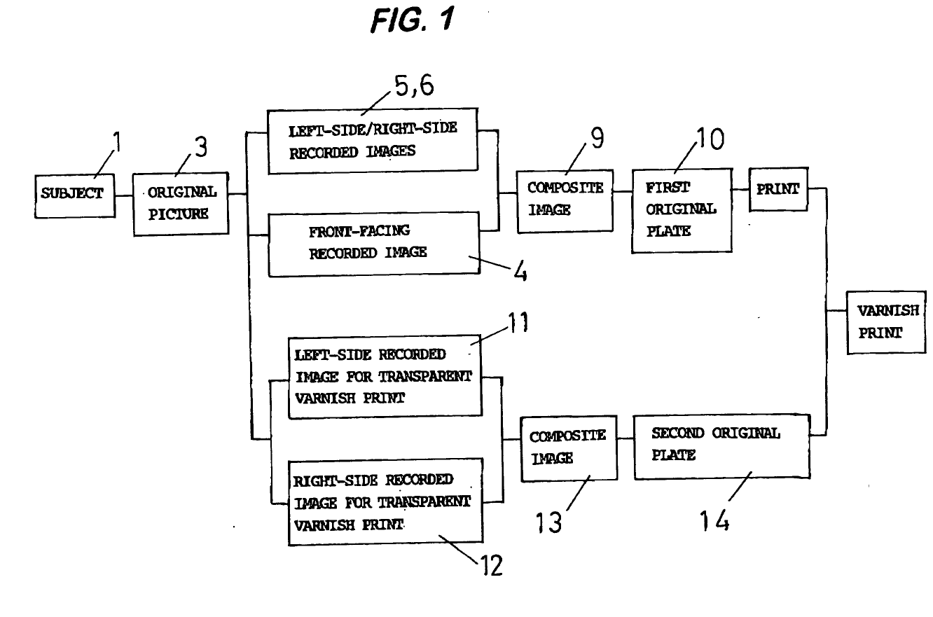

An example 1 of the present invention will be described based on FIGS. 1, 2, and 3.

The example 1 will explain a print method of executing a varnish finish print using a first original plate using a first composite image and a second original plate using a second composite image. The first composite image is obtained by combining a front-facing recorded image having 20% of the pixels thereof with respect to the number of the pixels of the first composite image with left-side and right-side recorded images which have been subjected to 80% to 0% of gradation processing. And the second composite image is obtained by combining the pixels of left-side and right-side recorded image which have been subjected to 100% to 0% of gradation processing respectively for the varnish print.

In the first example, an original picture is obtained by recording a subject from the front of it, and the left-side and right-side recorded images are obtained by recording the original picture from a left direction and a right direction offset from the front (front-facing direction) of the original picture at a predetermined angle.

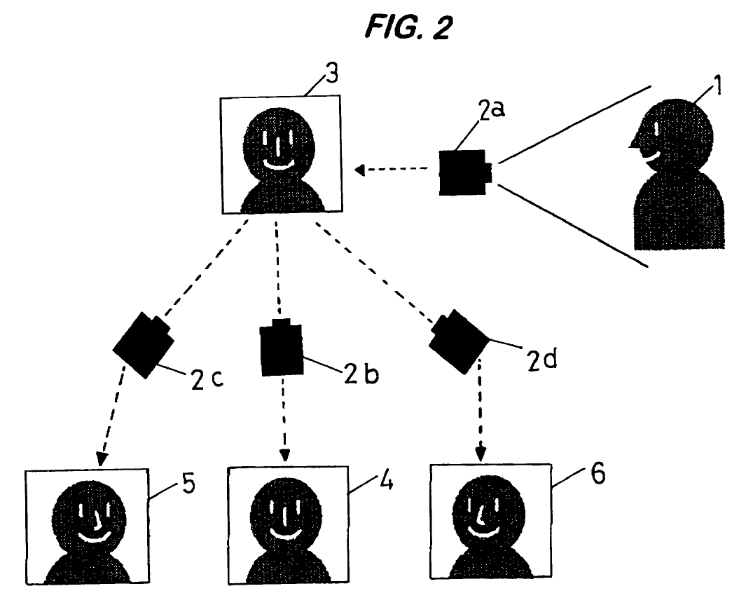

That is, the subject is not directly recorded from the front, left side, and right side thereof. This will be described below in detail mainly based on FIG. 2.

First, an original picture 3 is obtained by recording a subject 1 with a camera 2a as a first step.

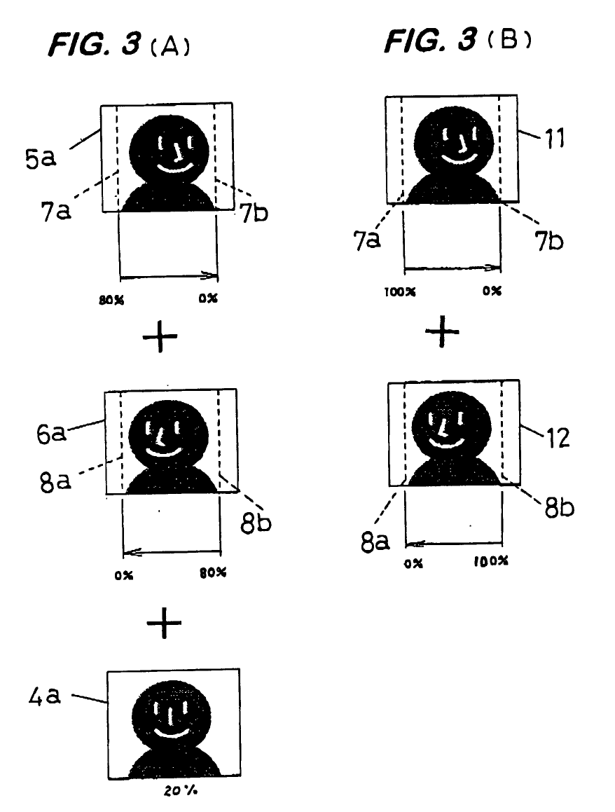

A front-facing recorded image 4 is obtained by recording the original picture 3 from the front of it with a camera 2b. A left-side recorded image 5 is obtained by recording the original picture 3 with a camera 2c at a position moved left from the front of the original picture 3. Further, a right-side recorded image 6 is obtained by recording the original picture 3 with a camera 2d at a position moved right from the front of the original picture 3. At this time, the front-facing recorded image 4, the left-side recorded image 5, and the right-side recorded image 6 have the same number of pixels. A front-facing recorded image 4a(FIG. 3(A)) whose pixel density has been reduced is obtained by extracting 20% of the pixels of the front-facing recorded image 4 obtained as described from the entire surface thereof.

Further, a left-side recorded image 5a (FIG. 3(A) and a right-side recorded image 6a (FIG. 3(A)), each of which has been subjected to 80% to 0% of the gradation processing, are obtained from the left-side recorded image 5 and the right-side recorded image 6.

The gradation processing will be described here mainly based on FIG. 3(A) and FIG. 3(B). In the first example, since the front-facing recorded image is combined in the amount of 20% of the composite image, first, 80% of the pixels of the left-side recorded image 5(FIG. 2) are extracted from the left-end border line 7a thereof to the right-end border line 7b thereof. Then, the left-side recorded image 5a, which has been subjected to the gradation processing, is obtained by gradually changing an extraction ratio so as to set it to 80% on the left-end border line 7a of the subject in the left-side recorded image and to 0% on the right-end border line 7b thereof. Note that the extraction ratios of both the side portions of the border lines 7a and 7b are set to 40%, respectively.

Further, 80% of the pixels of the right-side recorded image 6 (FIG. 2) are extracted from the left-end border line 8a thereof to the right-end border line 8b thereof. Then, the left-side recorded image 6a, which has been subjected to the gradation processing, is obtained by gradually changing the extraction ratio so as to set it to 80% on the right-end border line 8b of the subject in the right-side recorded image and to 0% on the left-end border line 8a thereof. Note that the extraction ratios of both the side portions of the border lines 8a and 8b are set to 40%, respectively.

The composite image whose pixel density is 80% of that of the original image on the entire surface thereof can be obtained by combining the left-side recorded image 5a with the right-side recorded image 6a each having been subjected to the gradation processing, which has been subjected to the gradation processing. The combination of the front-facing recorded image 4a having 20% of the pixels extracted therefrom with the above composite image results in a composite image 9 (FIG. 1) whose number of pixels coincides with the number of pixels of the original image, that is, whose number of pixels is 100% of the number of pixels of the original image.

When a first original plate 10 (FIG. 1) is made using the composite image 9 (FIG. 1) and a print is output using the first original plate 10 (FIG. 1), a print material having an increased front-facing-feeling keeping angle can be obtained.

The printed material can be finished by a transparent varnish print.

To execute the transparent varnish print, a left-side image used for the transparent varnish print is obtained by recording the original picture 3 (FIG. 1, FIG. 2) on a left side. Then, a left-side recorded image 11 for the transparent varnish print, which has been subjected to the gradation processing, is created by gradually changing the extraction ratio so as to set it to 100% on the left-end border line 7a of the subject in the left-side image and to 0% on the right-end border line 1b thereof. Note that the extraction ratios of both the side portions of the border lines 7a and 7b are set to 50%, respectively.

Further, a right-side image used for the transparent varnish print is obtained by recording the original picture 3 on a right side. Then, a right-side recorded image 12 for the transparent varnish print, which has been subjected to the gradation processing, is created by gradually changing the extraction ratio so as to set it to 100% on the right-end border line 8b of the subject in the right-side image and to 0% on the left-end border line 8a thereof. Note that the extraction ratios of both the side portions of the border lines 8a and 8b are set to 50%, respectively.

A second original plate 14 (FIG. 1) for the varnish print is made using a composite image 13 (FIG. 1) for the varnish print obtained by combining the left-side recorded image 11 with the right-side recorded image 12 each having been obtained as described above and the transparent varnish print is executed, thereby a printed material finished with transparent varnish can be obtained.

The transparent varnish intends to adjust light beams. In particular, the transparent varnish permits the directions of the subject such as a front direction, a right direction and a left direction to be recognized by deflecting luminous portions to thereby emphasize a illusionary front-facing-feeling by offsetting the luminous portions.

According to the first example, since the composite image is obtained by being added with some amount for example, 20%) of the pixels of the images recorded along optical axes offset left and right with respect to a front-facing optical axis, the front-facing-feeling can be kept even if the composite image is viewed from obliquely left and right directions.

Note that it is needless to say that the printed material can be made using only the first original version without executing the varnish print.

### EXAMPLE 2

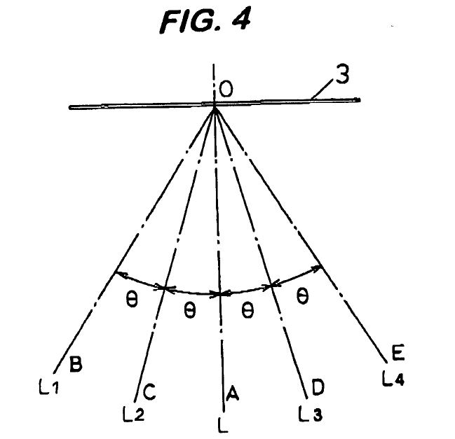

An example 2 of the present invention will be explained with reference to FIG. 4.

A front-facing recorded image A is obtained by recording the original picture 3 along an optical axis LO, oblique recorded images B and C are obtained by recording the original picture 3 along optical axes L₁O and L₂O, and then oblique recorded images D and E are further obtained by recording the original picture 3 along optical axes L₃O and L₄O. A composite image is created by combining 80% of the pixels of the front-facing recorded image A, 10% in total of the pixels of the oblique recorded images B and C, and 10% in total of the pixels of the oblique recorded images D and E. The present invention can be completed by outputting a print using the composite image as an original plate. Further, each 50% of the pixels of left-side and right-side recorded images for the transparent varnish print are extracted, and a second original plate for the varnish print is created from the thus extracted pixels. Then, a varnish finished printed material can be obtained by executing the transparent varnish print using the second original plate.

The angle θ employed in the above recording is 3° to 30°. The numbers of pixels extracted from the front-facing image A and the oblique images B, C, D, and E can be appropriately changed within the range in which the total number of the pixels is 100%.

While the preferable examples of the present invention have been described with reference to the accompanying drawings, the present invention is by no means limited to the above examples and it goes without saying that the present invention can be modified to various examples within the technical range which can be understood from the gist of the present invention.

According to the present invention, the original plate is made from the composite image produced from the images recorded along the optical axes offset left and right at a certain angle with respect to the front-facing optical axis, and a printed material is made using the original plate. Therefore, even if a person views the printed material in a somewhat wide range (for example, within an angle of about 20° on the left and right sides of the front-facing direction), the person has a illusionary feeling is if he or she views the printed material from the front of it, thereby an effect that the printed material is regarded as if it is viewed from the front of it can be obtained.

What is claimed is:

1. A print method of increasing a front-facing-feeling keeping angle comprising the steps of:
creating a composite image by adding the pixels of a left-side recorded image of a subject and/or the pixels of a right-side recorded image of the subject to the pixels of a front-facing recorded image of the subject;
making an original plate using the composite image; and
outputting a print using the original plate.

2. A print method of increasing a front-facing-feeling keeping angle according to claim 1, wherein each one of the left-side recorded image and the right-side recorded image or each plurality of the left-side recorded images and the right-side recorded images recorded at different positions are created.

3. A print method of increasing a front-facing-feeling keeping angle comprising the steps of:
creating a composite image by adding the pixels of a right-side recorded image of a subject to the pixels of a left-side recorded image of the subject; and
making an original plate using the composite image; and
outputting a print using the original plate.

4. A print method of increasing a front-facing-feeling keeping angle according to claim 3, wherein each one of the left-side recorded image and the right-side recorded image or each plurality of the left-side recorded images and the right-side recorded images recorded at different positions are created.

5. A print method of increasing a front-facing-feeling keeping angle comprising the steps of:
extracting the pixels of each of a left-side recorded image of a subject and a right-side recorded image of the subject at an extracting ratio of 100% to 0%;
creating a composite image by combining the thus extracted pixels such that a total of the extracting ratios of the pixels is 100% on the entire surface of the composite image at all times; and
making an original plate using the composite image; and
outputting a print using the original plate.

6. A print method of increasing a front-facing-feeling keeping angle according to claim 5, comprising the steps of:
extracting the pixels of the left-side recorded image of the subject by changing the extracting ratio in the range of 100% to 0% from one side edge of the left-side recorded image to the other side edge thereof;
extracting the pixels of the right-side recorded image of the subject by changing the extracting ratio in the range of 100% to 0% from the other side edge of the right-side recorded image to one side edge thereof according to the extracting ratio of the pixels of the left-side recorded image;
creating a composite image by combining the pixels extracted from the left-side recorded image with the pixels extracted from the right-side recorded image;
making an original plate using the composite image; and
outputting a print using the original plate.

7. A print method of increasing a front-facing-feeling keeping angle according to any one of claims 1, 3, and 5, wherein the left-side and right-side recorded images are recorded at positions moved at an angle of 3° to 60° from a front-facing direction.

8. A printed material having an increased front-facing-feeling keeping angle, wherein the printed material is made from a composite image acting as an original plate obtained by extracting the respective pixels of a front-facing recorded image of a subject, a left-side recorded image of the subject, and a right-side recorded image of the subject at an extracting ratio of 100% to 0% and by combining the thus extracted pixels such that a total of the extracting ratios of the extracted pixels is 100% on the entire surface of the composite image at all times.
